(19) United States
(12) Patent Application Publication
(10) Pub. No.: US 2025/0266184 A1
(43) Pub. Date: Aug. 21, 2025

(54) SYSTEM AND METHOD FOR GENERATING A FOCUSED X-RAY BEAM

(71) Applicant: Sigray, Inc., Concord, CA (US)

(72) Inventors: Benjamin Donald Stripe, Berkeley, CA (US); Wenbing Yun, Walnut Creek, CA (US); Janos Kirz, Berkeley, CA (US); Thomas James Smart, Oakland, CA (US); Mark Antoine Cordier, El Sobrante, CA (US); Sylvia Jia Yun Lewis, San Francisco, CA (US)

(21) Appl. No.: 19/052,937

(22) Filed: Feb. 13, 2025

Related U.S. Application Data
(60) Provisional application No. 63/554,062, filed on Feb. 15, 2024.

(51) Int. Cl. G21K 1/02

(52) U.S. Cl. CPC G21K 1/02

(57) ABSTRACT

An apparatus includes at least one x-ray source configured to generate x-rays and at least one capillary x-ray focusing optic configured to receive and focus at least some of the generated x-rays into a focused x-ray beam. The apparatus further includes at least one x-ray optical component configured to receive the generated x-rays and/or the focused x-ray beam such that a focus size δ₁ of the focused x-ray beam is smaller than a focus size δ₀ of the focused x-ray beam without the at least one x-ray optical component.

### CLAIM OF PRIORITY

This application claims the benefit of priority to U.S. Provisional Appl. No. 63/554,062 filed Feb. 15, 2024, which is incorporated in its entirety by reference herein.

### BACKGROUND

### Field

This application relates generally to x-ray microbeam apparatuses and x-ray microprobe based systems.

### Description of the Related Art

Systems for producing x-ray microbeams typically include an x-ray source and an x-ray focusing optic that receives some x-rays from the x-ray source and focuses the x-rays to a small spot. For many applications of such x-ray microbeams, important performance attributes include but are not limited to: small x-ray focus size, high flux density and/or total flux, achromaticity, and sufficiently large working distance (e.g., distance between the system to the focus). In particular, a small x-ray spot size on a sample (e.g., less than 10 microns; less than 3 micron; less than 300 nm) with high flux is often used for microanalytical applications, including microXRF, microXRD, and scanning x-ray microscopy.

However, there are various challenges to obtaining some or all of these attributes (e.g., high flux and small sample spot sizes) with a laboratory x-ray source due to low source brightness and challenges in producing x-ray focusing optics having a high source x-ray collection efficiency and a small point spread function. Axially (e.g., cylindrically) symmetric capillary x-ray focusing optics can provide high x-ray collection efficiencies although fabrication with small surface figure errors can be challenging. In particular, it can be difficult to produce x-ray focusing optics with a point spread function (PSF) smaller than the x-ray spot size to be used. Existing approaches to fabricating x-ray focusing optics have limitations to produce such small PSFs without significant degradation in yield and/or fabrication time (see, e.g., Sun et al., “A procedure for the characterization of monocapillary x-ray lenses as condensers for full-field transmission x-ray microscopes,” Front. Phys. 10.821549 (2022); Zeng et al., “Ellipsoidal and parabolic glass capillaries as condensers for x-ray microscopes,” Appl. Op. Vol. 47, No. 13, pp. 2376-2381 (2008); Huang et al., “Single-bounce monocapillaries for focusing synchrotron radiation: modeling, measurements and theoretical limits,” J. Synch. Rad. Vol. 13, pp. 74-84 (2006)). These methods primarily involve “shaping” the interior of a focusing x-ray optic by locally heating regions of a glass capillary to soften and move the heated zones in a prescribed fashion, akin to extremely high precision glass blowing.

### SUMMARY

In certain implementations, an apparatus comprises at least one x-ray source configured to generate x-rays and at least one capillary x-ray focusing optic configured to receive and focus at least some of the generated x-rays into a focused x-ray beam. The apparatus further comprises at least one x-ray optical component configured to receive the generated x-rays and/or the focused x-ray beam such that a focus size &1 of the focused x-ray beam is smaller than a focus size 80 of the focused x-ray beam without the at least one x-ray optical component.

In certain implementations, an apparatus comprises at least one x-ray source configured to generate x-rays and at least one capillary x-ray focusing optic configured to receive and focus at least some of the generated x-rays into a focused x-ray beam. The apparatus further comprises at least one x-ray optical component configured to receive the generated x-rays and/or the focused x-ray beam such that a collective point spread function (PSF) of the at least one x-ray focusing optic and the at least one x-ray optical component is below 1 micron.

### BRIEF DESCRIPTION OF THE DRAWINGS

FIGS. 1A and 1B schematically illustrate two examples of an apparatus in accordance with certain implementations described herein.

FIG. 1C schematically illustrates an example prior art system without the at least one x-ray optical component.

FIGS. 2A and 2B schematically illustrate two example apparatus in accordance with certain implementations described herein.

FIG. 3 schematically illustrates an example x-ray metrology system compatible with certain implementations described herein.

FIGS. 4A and 4B schematically illustrate an example knife edge scan and the one-dimensional derivative of the angles, respectively, in accordance with certain implementations described herein.

FIGS. 5A and 5B schematically illustrate two examples of at least one x-ray optical component comprising at least one refractive 3D optic and at least one mask, respectively, in accordance with certain implementations described herein.

FIGS. 6A and 6B schematically illustrates cross-sectional views of portions of two example contoured surface profiles of a refractive 3D optic in accordance with certain implementations described herein.

### DETAILED DESCRIPTION

Certain implementations described herein provides an x-ray microbeam apparatus comprising a capillary x-ray focusing optic mirror and an x-ray optical component configured to correct at least some figure errors of the capillary x-ray focusing optic to achieve a small x-ray source focus (e.g., submicron focus) with high x-ray flux density. In particular, certain implementations comprise a small point spread function (PSF) x-ray focusing optics.

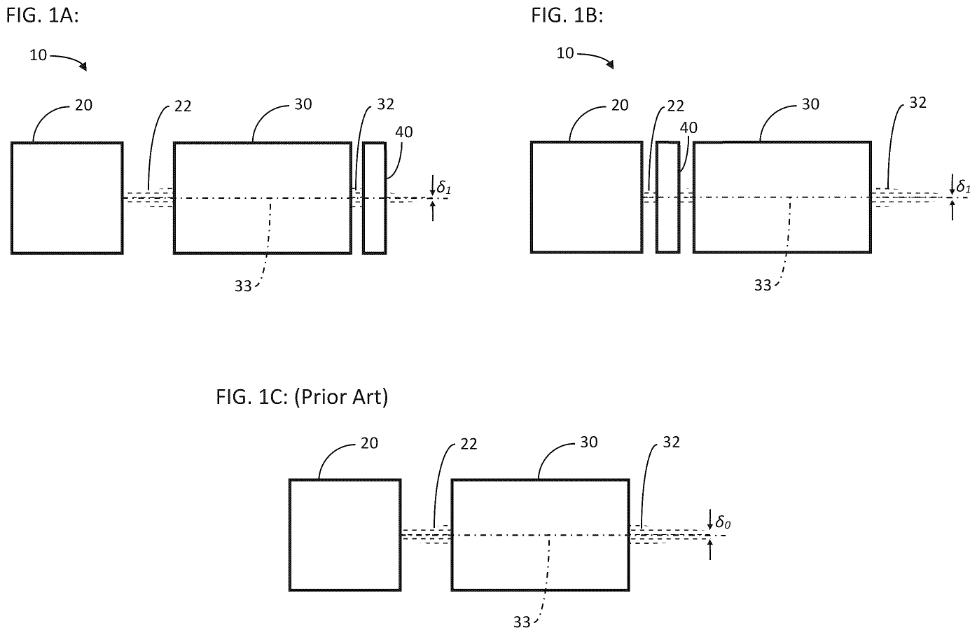

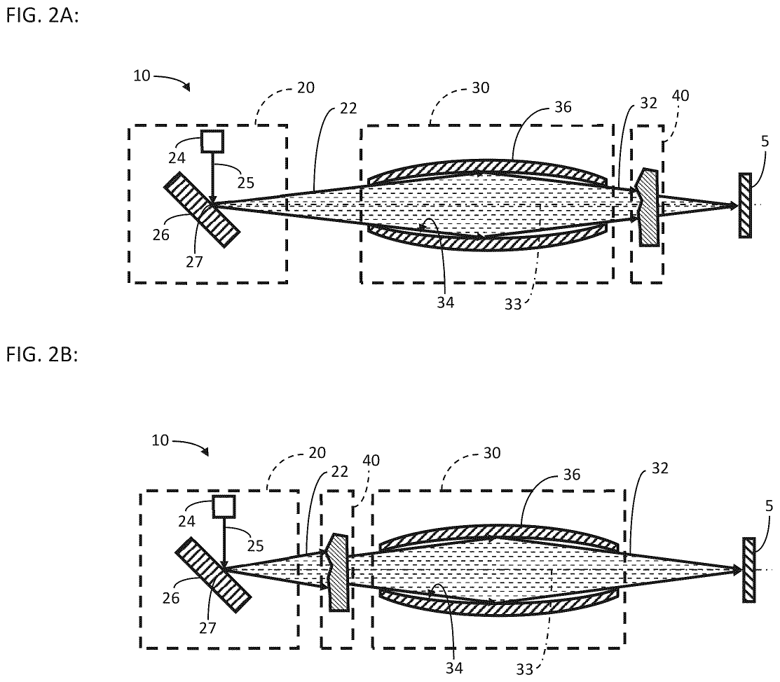

FIGS. 1A and 1B schematically illustrate two examples of an apparatus 10 in accordance with certain implementations described herein. The apparatus 10 comprises at least one x-ray source 20 configured to generate x-rays 22, at least one capillary x-ray focusing optic 30 configured to receive and focus at least some of the generated x-rays 22 into a focused x-ray beam 32, and at least one x-ray optical component 40 configured to receive the generated x-rays 22 and/or the focused x-ray beam 32 such that a focus size δ₁ of the focused x-ray beam 32 is smaller than a focus size δ₀ of the focused x-ray beam 32 without the at least one x-ray optical component 40. In FIG. 1A, the at least one x-ray optical component 40 is downstream from the at least one capillary x-ray focusing optic 30, while in FIG. 1B, the at least one x-ray optical component 40 is upstream from the at least one capillary x-ray focusing optic 30. FIG. 1C schematically illustrates an example prior art system without the at least one x-ray optical component 40.

The full-width-at-half-maximum (FWHM) focus size δ of a focused x-ray beam 32 generated by an apparatus 10 in accordance with certain implementations described herein (e.g., diameter or width of the focused x-ray beam 32 at the focus in a cross-sectional plane substantially perpendicular to the x-ray propagation axis 33) can be approximately expressed as:

$$δ = {[ {( S / M )}^{2} + {P}^{2} ]}^{1 / 2} \qquad ( 1 )$$

where S is the FWHM x-ray source size (e.g., diameter or width of the x-ray source spot 27), M is the demagnification of the x-ray source 20 by the at least one capillary x-ray focusing optic 30, and P is the FWHM focus size of the at least one capillary x-ray focusing optic 30 (e.g., the FWHM of the x-ray focus size of the at least one capillary x-ray focusing optic 30 with an infinitely small spot size of the at least one x-ray source 20 and/or infinitely large M). The x-ray flux F of the apparatus 10 with the at least one capillary x-ray focusing optic 30 can be approximately expressed as:

$$F = B * G * π * {( S / 2 )}^{2} * H \qquad ( 2 )$$

where B is the x-ray source brightness in x-rays per millimeter square and per milliradian square, G is the solid angle of x-ray collection, and H is the efficiency of the at least one capillary x-ray focusing optic 30. The x-ray flux density F_{d} of a focused x-ray beam 32 can be approximately expressed as:

$${F}_{d} = F / [ π * {( δ / 2 )}^{2} ] = B * G * H * {( S / δ )}^{2} = B * G * H * {M}^{2} / [ 1 + {( M * P / S )}^{2} ] \qquad ( 3 )$$

For electron impact x-ray sources 20 which emit x-rays 22 over a large solid angle, the at least one capillary x-ray focusing optic 30 with a solid angle of x-ray collection G from the at least one x-ray source 20 (e.g.,

$$\sqrt{G} * \frac{1}{2} )$$

is limited to the numerical aperture of the at least one capillary x-ray focusing optic 30.

Exp. (1) shows that the focus of the apparatus 10 is limited by a demagnified source image (S/M) and by the point spread function (PSF) P of the at least one capillary x-ray focusing optic 30. Exp. (3) shows that a small ratio M*P/S (e.g., the ratio of the focus size of the at least one capillary x-ray focusing optic 30 to the demagnified x-ray source spot size S/M is less than 1) can reduce (e.g., minimize) its effect on the reduction of x-ray flux density F_{d}. For example, the reduction of F_{d} can be 20%, 50%, and 80% for P*M/S=0.5, 1, and 2, respectively.

In certain implementations, the apparatus 10 is configured to generate a focused x-ray beam 32 having a focus size less than 10 microns (e.g., less than 3 microns, less than 1 micron; less than 0.5 micron; less than 0.3 micron) with an x-ray source spot size S less than 25 microns (e.g., less than 10 microns; less than 3 microns; less than 1 micron) and/or with a demagnification M greater than 1 (e.g., greater than 3; greater than 5; greater than 10) and a point spread function P less than 10 microns (e.g., less than 3 microns; less than 1 micron; less than 0.5 micron; less than 0.3 micron). In certain implementations, to preserve the brightness of the at least one x-ray source 20, P is approximately equal to the ratio S/M, or at least within the range of 10% to 100% (e.g., in the range of 20% to 80%) of the ratio S/M. In certain implementations, the value of M is configured to obtain a small focus (e.g., M in the range of 1×to 10×). One non-limiting example of obtaining a spot size less than 0.5 micron is using at least one x-ray source 20 with a spot size of 2 microns, a demagnification M of 7×, and a point spread function P of the at least one capillary x-ray focusing optic 30 of 0.4 micron. In certain implementations, the apparatus 10 is configured to provide a working distance (e.g., the distance between the output end of the at least one capillary x-ray focusing optic 30 and the focus) that is less than 50 mm (e.g., less than 20 mm; less than 5 mm).

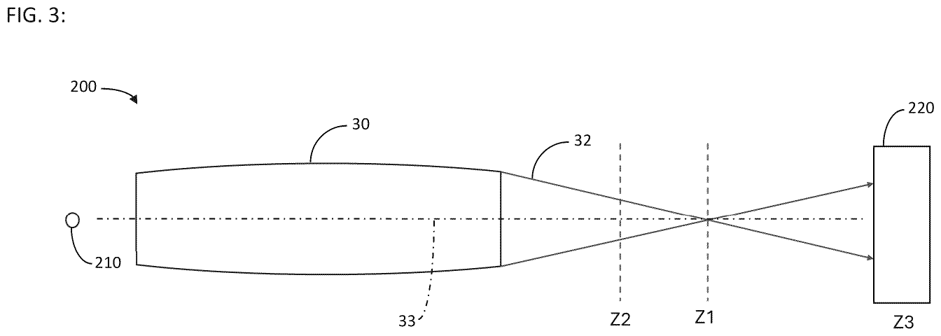

FIGS. 2A and 2B schematically illustrate two example apparatus 10 in accordance with certain implementations described herein. In FIG. 2A, the at least one capillary x-ray focusing optic 30 receives generated x-rays 22 from the at least one x-ray source 20 and the at least one x-ray optical component 40 receives the focused x-ray beam 32 from the at least one capillary x-ray focusing optic 30 and modifies the spatial distribution of the focused x-ray beam 32. In FIG. 2B, the at least one x-ray optical component 40 receives generated x-rays 22 from the at least one x-ray source 20 and modifies the spatial distribution of the generated x-rays 22, and the at least one capillary x-ray focusing optic 30 receives the generated x-rays 22 from the at least one x-ray optical component 40. As seen in FIGS. 2A and 2B, the focused x-ray beam 32 can impinge a sample 5 with the focus of the focused x-ray beam 32 on or in the sample 5.

### X-Ray Source

In certain implementations, the at least one x-ray source 20 comprises a reflection-geometry x-ray source 20 comprising at least one electron beam generator 24 configured to generate at least one electron beam 25 and at least one x-ray target 26 configured to generate the x-rays 22 in response to being irradiated by the at least one electron beam 25 from the at least one electron beam generator 24. In certain implementations, a micro focus x-ray source 20 with a small x-ray source spot size (e.g., less than 25 microns; less than 10 microns; less than 3 microns; less than 1 micron) is used. In certain implementations, the electron beam energy of the at least one electron beam 25 is in a range of 5 kVp to 100 kVp. In certain implementations, the shape of the at least one electron beam 25 on the at least one x-ray target 26 is elongated with a ratio of the long dimension to the short dimension larger than 1.5×(e.g., larger than 3×; larger than 10×) and the x-rays 22 emitted from the at least one x-ray source 20 have a small takeoff angle relative to the surface of the at least one x-ray target 26 (e.g., less than 35 degrees; less than 20 degrees; less than 10 degrees), resulting in a reduced x-ray source spot size viewed from the x-ray takeoff angle. In certain implementations, the at least one x-ray target 26 of the reflection-geometry x-ray source 20 comprises at least one transition metal target material (e.g., Cr, Fe, Co, Cu, etc.) or a target material configured to produce a strong characteristic line of energy less than 25 keV (e.g., less than 12 keV; less than 8 keV; less than 4 keV). In certain implementations, the at least one x-ray source 20 comprises a plurality of x-ray-generating target materials (e.g., Cu, Cr, Co, W, Au, Mo. Rh, Pd, Ag). Lower x-ray energies (e.g., less than 25 keV; less than 10 keV; less than 8 keV) can be more efficiently collected and focused by the capillary x-ray focusing optic 30 as the critical angle for x-ray reflection is inversely proportional to x-ray energy. In certain implementations, the at least one x-ray source 20 has a plurality of x-ray targets 26 configured to provide predetermined spectral properties (e.g., characteristic lines). To achieve high brightness, the at least one x-ray source 20 can have the at least one x-ray target 26 in thermal contact with a high thermal conductivity substrate such as diamond (e.g., formed using sputter deposition on the substrate). In certain implementations, the at least one x-ray target 26 has a thermal conductive path to the vacuum system (e.g., vacuum hosing) of the at least one x-ray source 20. In certain other implementations, the at least one x-ray source 20 comprises a transmission-geometry x-ray source 20. In certain implementations, the at least one x-ray source 20 comprises a linear accumulation x-ray source 20 (see, e.g., U.S. Pat. No. 9,390,881).

In certain implementations, the at least one x-ray source 20 and the at least one capillary x-ray focusing optic 30 are pre-aligned with one another (e.g., to reduce or minimize a focus of the focused x-ray beam 32). For example, the at least one x-ray source 20 and the at least one capillary x-ray focusing optic 30 can be mechanically attached to one other as a monolithic microbeam system. The microbeam system can be sufficiently compact and motorized to move such that the focused x-ray beam 32 emitted from the at least one capillary x-ray focusing optic 30 is controllably scanned across a sample 5.

### Capillary X-Ray Focusing Optic

In certain implementations, the capillary x-ray focusing optic 30 has an inner surface 34 with a surface profile comprising at least one segment of a rotationally symmetric quadric surface (e.g., ellipsoid, paraboloid, hyperboloid, etc.) having at least one focal point. The capillary x-ray focusing optic 30 can be aligned to the at least one x-ray source 20 such that one of the focal points of the quadric surface is at the x-ray source spot 27. In certain implementations, the capillary x-ray focusing optic 30 comprises a Wolter optic (e.g., comprising an ellipsoidal segment and a hyperboloid segment downstream from the ellipsoidal segment). The Wolter optic can be configured to produce an image of the x-ray source spot 27 on or in a sample 5 and to demagnify the x-ray source spot 27. Capillary x-ray focusing optics 30 can provide various advantages for x-ray focusing applications, including but not limited to: large numerical aperture (e.g., 2 times the critical angle), achromaticity, concurrent focusing in two orthogonal directions, short working distances, and/or high transmission efficiency.

In certain implementations, the profile of the inner reflecting surface of the capillary x-ray focusing optic 30 is measured to determine its deviation from the predetermined profile (e.g., using either optical and/or x-ray metrology methods). An example optical metrology method uses one or more high resolution optical microscopes configured to have an optical imaging axis perpendicular to the long axis of the capillary x-ray focusing optic 30. The one or more optical microscopes can measure the capillary x-ray focusing optic 30 as the capillary x-ray focusing optic 30 is suspended in air, with the long axis parallel to gravity. In certain implementations, at least one optical microscope is moved relative to the capillary x-ray focusing optic 30 along the long axis of the capillary x-ray focusing optic 30 to measure the inner diameter of the capillary x-ray focusing optic 30. In certain implementations, the capillary x-ray focusing optic 30 is also rotated relative to the at least one optical microscope during the measurement of the inner surface. Rotation can also be used to obtain radial shape errors.

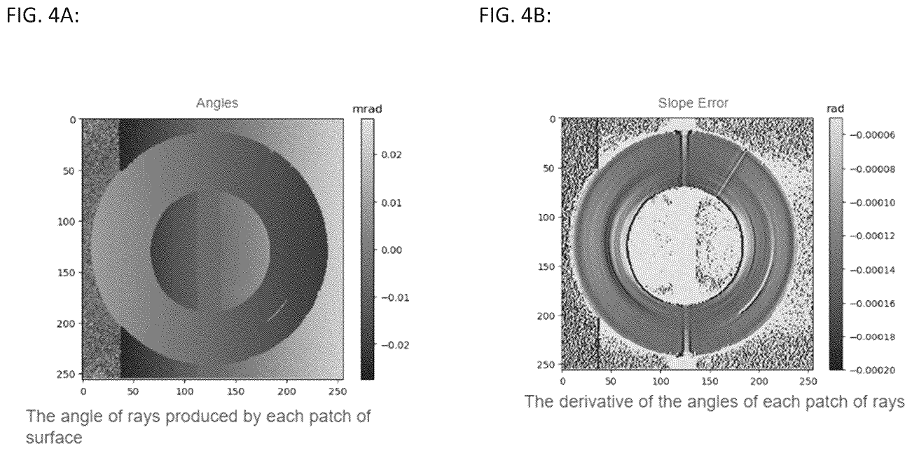

In certain implementations, x-ray metrology can be used (e.g., alternatively or in addition to optical metrology) to evaluate the capillary x-ray focusing optic 30. FIG. 3 schematically illustrates an example x-ray metrology system 200 compatible with certain implementations described herein. The x-ray metrology system 200 of FIG. 3 comprises a microfocus x-ray source 210 configured to illuminate the capillary x-ray focusing optic 30 and a two-dimensional x-ray camera 220 fixed at a stationary position Z3. In certain implementations, the stationary position Z3 is past the focal point of the capillary x-ray focusing optic 30. A knife edge is scanned at a first distance Z1 from the exit of the capillary x-ray focusing optic 30, with the position of the knife edge at Z1 corresponding to the focal plane or the focus of the capillary x-ray focusing optic 30. In certain implementations, knife edge scans are also performed at a second distance Z2 from the exit of the capillary x-ray focusing optic 30. The scanning of the knife edge (e.g., at Z1 and/or Z2) can be performed in two substantially orthogonal directions, both of which are substantially orthogonal to the x-ray propagation axis 33. By processing the measured x-ray beam profiles (e.g., ray tracing), the surface profile of the capillary x-ray focusing optic 30 can be determined.

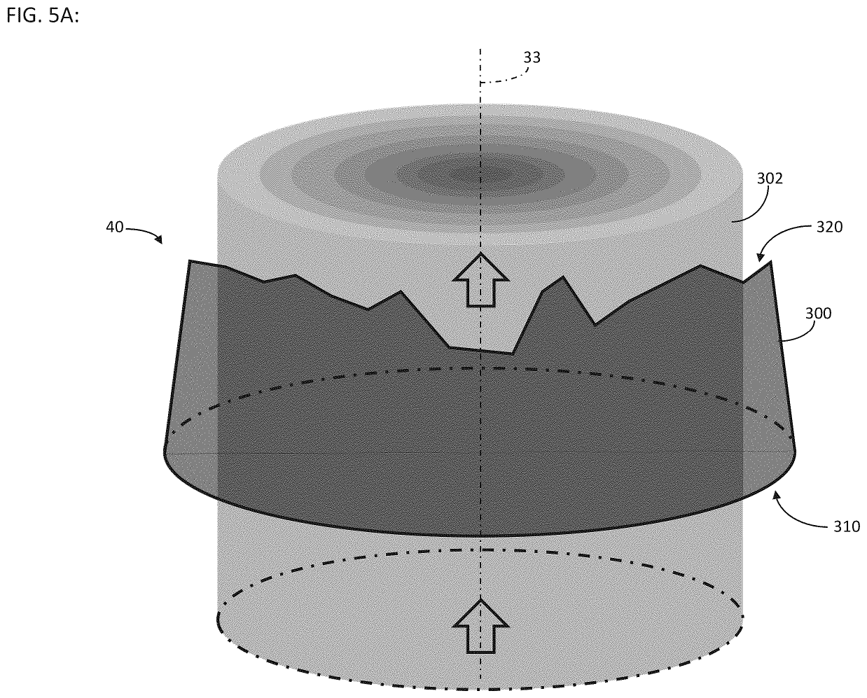

FIGS. 4A and 4B schematically illustrate an example knife edge scan and the one-dimensional derivative of the angles, respectively, in accordance with certain implementations described herein. The knife edge scan of FIG. 4A can be used to determine the reflection angle at each patch of the inner surface of the capillary x-ray focusing optic 30, and the one-dimensional derivative of the angles of FIG. 4B can provide the slope error. In certain implementations, knife edge scans at positions Z1 and Z2 are used to determine the intensity lost in each pixel of the image obtained by the two-dimensional x-ray camera 220 by correlation with the position of the knife edge. This information can be used to calculate rays responsible for the intensity in each part of the image. In an ideal case, one scan cuts the focus of the capillary x-ray focusing optic 30 as the highest resolution can be achieved for the fewest number of images. Images collected further from the focus can be done as step sizes that would give similar or greater angular resolution than the scan at the focal plane. Important information from the metrology measurement can include, but are not limited to, straightness errors of some segments of the capillary x-ray focusing optic 30 from a main (e.g., mean) axis of the whole capillary x-ray focusing optic 30 and surface figure errors of one or more portions of the capillary x-ray focusing optic 30 (e.g., deviation from the predetermined surface figure).

In certain implementations, a commercial interferometric system is used (e.g., non-limiting examples include Kenyence VK-300; Lumetrics OptiGauge II; Bristol Instruments). In certain implementations, thicknesses of boundaries (e.g., walls, central hole, etc.) are measured at specific points along the capillary x-ray focusing optic 30 by relative motorized motion of the capillary x-ray focusing optic 30 to the interferometric system. These thickness measurements can be compared to a reference flat to determine form error.

In certain implementations, the surface profile of the capillary x-ray focusing optic 30 is close to ideal, but has at least one deviation (e.g., kink) in the straightness of the capillary x-ray focusing optic 30. In such cases, the capillary x-ray focusing optic 30 can be sectioned at the at least one deviation and can then be reattached to reduce (e.g., minimize) the number of deviations. Reattachment can occur using a mechanical holder and/or adhesive, such as epoxy. To align the portions of the capillary x-ray focusing optic 30, a visible light laser and/or x-rays can be used. Alternatively, or in addition, the surface profile of the capillary x-ray focusing optic 30 can be measured using one or more optical microscopes that move relative to the capillary x-ray focusing optic 30.

### X-Ray Optical Component

In certain implementations, the at least one x-ray optical component 40 comprises a three-dimensional (3D) microstructure configured to correct for surface errors of the at least one capillary x-ray focusing optic 30 to obtain a finer focus of the focused x-ray beam 32. For example, the 3D microstructure can be configured to reduce (e.g., minimize; prevent) contributions to the focused x-ray beam 32 emitted by the apparatus 10 from surface errors of predetermined regions of the at least one capillary x-ray focusing optic 30.

In certain implementations, the at least one capillary x-ray focusing optic 30 comprises nested capillary x-ray focusing optics 30 having one or more capillary x-ray focusing optics 30 nested inside one or more capillary x-ray focusing optics 30. The capillary x-ray focusing optics 30 can have substantially the same maximum x-ray incidence angle for focusing x-rays of a predetermined maximum x-ray energy. The maximum x-ray incidence angles on at least two nested capillary x-ray focusing optics 30 can be different from one another by more than 20% (e.g., more than 50%; more than 100%). In certain implementations, a single x-ray optical component 40 is configured to at least partially compensate (e.g., correct) for some figure errors for at least one of the nested capillary x-ray focusing optics 30. In certain implementations, a single x-ray optical component 40 is configured to at least partially compensate (e.g., correct) for some figure errors for at least two of the nested capillary x-ray focusing optics 30.

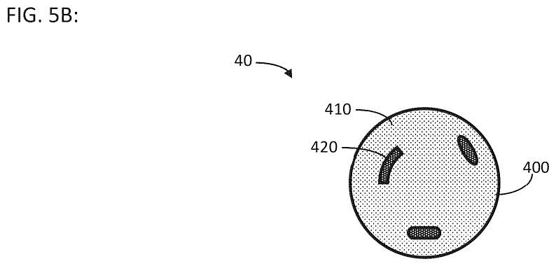

FIGS. 5A and 5B schematically illustrate two examples of at least one x-ray optical component 40 comprising at least one refractive 3D optic 300 and at least one mask 400, respectively, in accordance with certain implementations described herein. In certain implementations, the at least one x-ray optical component 40 either at least one refractive 3D optic 300, at least one mask 400, or both at least one refractive 3D optic 300 and at least one mask 400 (e.g., both a refractive 3D optic 300 and a mask 400 in a unitary structure). In certain implementations, the at least one x-ray optical component 40 (e.g., comprising a refractive 3D optic 300 and a mask 400) are configured to at least partially compensate (e.g., correct) for figure errors of the at least one capillary x-ray focusing optic 30 to achieve a collective PSF of the optical chain (e.g., the combination the at least one x-ray focusing optic 30 and the at least one x-ray optical component 40) that is below 1 micron (e.g., less than 0.5 micron; less than 0.4 micron; less than 0.3 micron, etc.).

In certain implementations, as shown in FIG. 5A, the at least one x-ray optical component 40 comprises at least one refractive 3D optic 300 (e.g., corrective plate) configured to be used in combination with the at least one capillary x-ray focusing optic 30. The at least one refractive 3D optic 300 can be configured to allow an x-ray beam 302 (e.g., at least some of the generated x-rays 22 and/or the focused x-ray beam 32) to propagate through the refractive 3D optic 300, such that predetermined changes of phase and/or wavefront are applied to the propagating x-ray beam 302. The predetermined changes of phase and/or wavefront can at least partially compensate (e.g., correct) for surface errors of the at least one capillary x-ray focusing optic 30 such that a FWHM focus size 8 of the focused x-ray beam 32 (e.g., impinging a sample 5) is less than 10 microns (e.g., less than 3 microns, less than 1 micron; less than 0.5 micron; less than 0.3 micron).

As shown in FIG. 5A, the x-ray beam 302 propagates along the x-ray propagation axis 33, impinges a first surface portion 310 of the refractive 3D optic 300, and emanates from a second surface portion 320 of the refractive 3D optic 300. The refractive 3D optic 300 of FIG. 5A is configured to be between the at least one x-ray source 20 and the at least one capillary x-ray focusing optic 30, and the x-ray beam 302 prior to impinging the first surface portion 310 has a substantially uniform phase and/or wavefront (e.g., the x-ray beam 302 comprising the generated x-rays 22 from the at least one x-ray source 20), and the x-ray beam 302 after emanating from the second surface portion 320 has a substantially non-uniform phase and/or wavefront. Alternatively, the refractive 3D optic 300 is configured to be between the at least one capillary x-ray focusing optic 30 and the focus of the at least one capillary x-ray focusing optic 30, and the x-ray beam 302 prior to impinging the first surface portion 310 has a substantially non-uniform phase and/or wavefront (e.g., the x-ray beam 302 comprising the focused x-ray beam 32 from the at least one capillary x-ray focusing optic 30), and the x-ray beam 302 after emanating from the second surface portion 320 has a substantially uniform phase and/or wavefront. In both of these configurations, the refractive 3D optic 300 is configured to compensate (e.g., correct) for optical errors in the phase and/or wavefront that result from portions of the x-ray beam 302 reflecting from aberrant regions of the at least one capillary x-ray focusing optic 30.

While FIG. 5A schematically shows an implementation in which the substantially modified phase and/or wavefront have values that are substantially symmetric about the x-ray propagation axis 33, the values of the substantially modified phase and/or wavefront in certain other implementations are non-symmetric about the x-ray propagation axis 33 (e.g., vary with angle about the x-ray propagation axis 33). In certain implementations, one of the first surface portion 310 and the second surface portion 320 is substantially flat and the other of the first surface portion 310 and the second surface portion 320 is substantially contoured (see, e.g., FIG. 5A), while in certain other implementations, both of the first surface portion 310 and the second surface portion 320 are substantially contoured. In certain implementations, the contoured surface portion (e.g., the second surface portion 320) comprise sharp features (see, e.g., FIG. 5A), in certain other implementations, the contoured surface portion comprises relatively smooth features that still exhibit significant topology to affect the phase and/or wavefront of the propagating x-ray beam 302 (e.g., sufficient topology to correct optical phase and/or wavefront errors due to reflections from aberrant portions of the at least one capillary x-ray focusing optic 30).

In certain implementations (e.g., to reduce or minimize x-ray attenuation by the refractive 3D optic 300), the refractive 3D optic 300 comprises one or more materials consisting essentially of low atomic number (Z) elements having atomic numbers less than 15 (e.g., organic materials; SU-8 resist; materials comprising at least 40% volume concentration of low Z elements, including but not limited to: H, Li, Be, B, C, and N). For example, the at least one refractive 3D optic 300 can comprise at least one polymer material, examples of which include but are not limited to: polyimide, polylactic acid, and photopolymers. In certain implementations, the at least one refractive 3D optic 300 is fabricated using an additive or subtractive manufacturing process (e.g. 3D printing; 3D lithography). In certain implementations, the at least one refractive 3D optic 300 comprises features (e.g., 2D features; 3D features) with outer dimensions less than 20 microns (e.g., less than 5 microns; less than 1 micron) in at least one direction (e.g., in two substantially orthogonal directions; in three substantially orthogonal directions). In certain implementations, the at least one refractive 3D optic 300 is configured to be either upstream or downstream from the at least one capillary x-ray focusing optic 30 (e.g., ellipsoidal optic or Wolter optic). In certain other implementations in which the at least one capillary x-ray focusing optic 30 comprises two separate capillary x-ray focusing optics 30 (e.g., two separate paraboloidal mirrors; a Wolter optic comprising an individual hyperboloidal mirror and an individual ellipsoidal mirror), the at least one refractive 3D optic 300 is configured to be between the two separate capillary x-ray focusing optics 30.

In certain implementations, the thickness and lateral profile of the 3D refractive optic 300 (e.g., corrector plate) is calculated by measuring the wavefront of the at least one capillary x-ray focusing optic 30 downstream past the focus of the at least one capillary x-ray focusing optic 30. For example, such measurements can be obtained by rotating a knife edge being impinged by the focused x-ray beam 32 throughout at least 180 degrees (e.g., more than 240 degrees; more than 360 degrees) in steps (e.g., less than 1 degree; less than 5 degrees; less than 10 degrees, etc.) to measure a rotationally variant wavefront error. These measurements can be made in combination with a coherent x-ray source, such as a synchrotron x-ray source or a laboratory source of x-rays that is sufficiently monochromatic (e.g., greater than 40%; greater than 50%; greater than 80%, etc. within a predetermined characteristic x-ray energy) and/or with x-rays that propagate through a monochromator. In certain implementations, the at least one refractive 3D optic 300 is designed and configured in correspondence of the measured wavefront error of the at least one capillary x-ray focusing optic 30. In certain implementations, the at least one refractive 3D optic 300 is designed and configured to improve a straightness of the at least one capillary x-ray focusing optic 30. The wavefront error can then be used to develop the at least one refractive 3D optic 300, which can be placed either upstream or downstream from the at least one capillary x-ray focusing optic 30. In certain implementations, the at least one refractive 3D optic 300 is attached to the at least one capillary x-ray focusing optic 30. In certain implementations, the at least one capillary x-ray focusing optic 30 has relatively small errors (e.g., PSF less than 3 microns; PSF less than 2 microns; PSF less than 1 micron) and the 3D refractive optic 300 is configured to bring the complete PSF of the apparatus 10 to less than 1 micron (e.g., less than 0.5 micron; less than 0.4 micron; less than 0.3 micron).

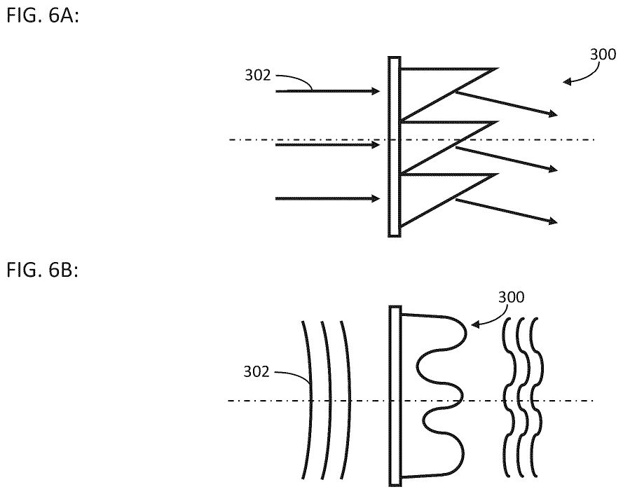

FIGS. 6A and 6B schematically illustrates cross-sectional views of portions of two example contoured surface profiles (e.g., height profiles) of a refractive 3D optic 300 in accordance with certain implementations described herein. The example contoured surface profile of FIG. 6A comprises a 3D staircase profile on a substrate and is configured to cause angular changes of x-rays in portions of the x-ray beam 302 that at least partially compensate (e.g., correct) for straightness error of a surface segment of the at least one capillary x-ray focusing optic 30 (e.g., the angular changes having magnitudes that are substantially equal to the angular deviation of the centerline of the surface segment from the main centerline of the capillary x-ray focusing optic 30 with opposite sign). In certain other implementations, straightness error is at least partially compensated (e.g., corrected) by mechanical bending at least one segment of the capillary x-ray focusing optic 30, such that at least one axis of the at least one segment is aligned to a main axis of the capillary x-ray focusing optic 30. In certain implementations, the mechanical bending is used in combination with the refractive 3D optic 300 to compensate (e.g., correct) for some or all of the figure errors of the capillary x-ray focusing optic 30.

The example contoured surface portion of FIG. 6B comprises a 3D structure on a substrate and is configured to cause phase changes in portions of the x-ray beam 302 that compensate (e.g., correct) for cylindrical symmetric shape errors (e.g., figure errors) along the axis of the at least one capillary x-ray focusing optic 30 (e.g., the phase changes having magnitudes that are substantially equal to phase changes of aberrant surface portions of the capillary x-ray focusing optic 30 with opposite sign). In certain implementations, the refractive 3D optic 300 is configured to correct astigmatism of the at least one capillary x-ray focusing optic 30. In certain implementations, the refractive 3D optic 300 is configured to simultaneously correct multiple (e.g., all) figure errors (e.g., straightness, shape errors, and astigmatism) of the at least one capillary x-ray focusing optic 30. In certain implementations, a plurality of refractive 3D optics 300 is used to simultaneously correct some or all the figure errors (e.g., straightness; shape errors).

In certain implementations, as shown in FIG. 5B, the at least one x-ray optical component 40 comprises at least one mask 400 comprising at least one x-ray transmissive region 410 and at least one x-ray absorptive region 420. The at least one mask 400 is configured to allow some x-rays of the x-ray beam 302 (e.g., at least some of the generated x-rays 22 and/or the focused x-ray beam 32) to propagate through the at least one mask 400, and to block other x-rays of the x-ray beam 302 from propagating through the at least one mask 400. For example, the at least one mask 400 can inhibit (e.g., block; prevent) x-rays from impinging specific regions of the at least one capillary x-ray focusing optic 30 that have previously been determined to have substantial surface errors from contributing to the FWHM focus size 8 of the focused x-ray beam 32 (e.g., substantial surface errors being surface errors that would add at least 1 micron to the FWHM focus size 8 of the focused x-ray beam 32). For another example, the at least one mask 400 can inhibit (e.g., block; prevent) x-rays that reflect from the specific regions of the at least one capillary x-ray focusing optic 30 from contributing to the FWHM focus size 8 of the focused x-ray beam 32. For example, the at least one mask 400 can be positioned within the path of the focused x-ray beam 32 to block x-rays reflected from sections of the at least one capillary x-ray focusing optic 30 having straightness error or having surface profiles deviating from the predetermined profile by more than a predetermined value in the reflection plane (e.g., more than 200 nm; more than 50 nm; more than 10 nm; more than 2 nm), while allowing other x-rays reflected by other sections having adequate surface profiles to propagate through.

In certain implementations, the at least one mask 400 is upstream of the at least one capillary x-ray focusing optic 30, while in certain other implementations, the at least one mask 400 is downstream from the at least one capillary x-ray focusing optic 30. In certain other implementations in which the at least one capillary x-ray focusing optic 30 comprises two separate capillary x-ray focusing optics 30, the at least mask 400 is configured to be between the two separate capillary x-ray focusing optics 30. The shape/pattern of the at least one mask 400 can be designed based on metrology measurements of the at least one capillary x-ray focusing optic 30. In certain implementations, the at least one x-ray transmissive region 410 comprises one or more materials consisting essentially of low atomic number (Z) elements having atomic numbers less than 15 (e.g., organic materials; polymers; SU-8 resist; materials comprising at least 40% volume concentration of low Z elements, including but not limited to: H, Li, Be, B, C, and N). In certain implementations, the at least one x-ray absorptive region 420 comprises one or more materials consisting essentially of one or more atomic elements having atomic numbers greater than 15 (e.g., metals).

While certain implementations are described herein with regard to using the at least one x-ray optical component 40 with at least one capillary x-ray focusing optic 30, in certain other implementations, the at least one x-ray optical component 40 is used with at least one capillary x-ray collimating optic (e.g., single paraboloids). For example, the apparatus 10 can comprise at least one x-ray source 20 configured to generate x-rays 22, at least one capillary x-ray collimating optic (e.g., single paraboloid) configured to receive and collimate at least some of the generated x-rays 22 into a collimated x-ray beam, and at least one x-ray optical component 40 configured to receive the generated x-rays 22 and/or the collimated x-ray beam such that a divergence angle of the collimated x-ray beam (e.g., in a range of 1 microradian to 50 microradians) is smaller than a divergence angle of the collimated x-ray beam without the at least one x-ray optical component 40. The at least one x-ray optical component 40 can be downstream from the at least one capillary x-ray collimating optic, or the at least one x-ray optical component 40 can be upstream from the at least one capillary x-ray collimating optic.

Although commonly used terms are used to describe the systems and methods of certain implementations for ease of understanding, these terms are used herein to have their broadest reasonable interpretations. Although various aspects of the disclosure are described with regard to illustrative examples and implementations, the disclosed examples and implementations should not be construed as limiting. Conditional language, such as “can,” “could,” “might,” or “may,” unless specifically stated otherwise, or otherwise understood within the context as used, is generally intended to convey that certain implementations include, while other implementations do not include, certain features, elements, and/or steps. Thus, such conditional language is not generally intended to imply that features, elements, and/or steps are in any way required for one or more implementations. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Conjunctive language such as the phrase “at least one of X, Y, and Z,” unless specifically stated otherwise, is to be understood within the context used in general to convey that an item, term, etc. may be either X, Y, or Z. Thus, such conjunctive language is not generally intended to imply that certain implementations require the presence of at least one of X, at least one of Y, and at least one of Z.

Language of degree, as used herein, such as the terms “approximately,” “about,” “generally,” and “substantially,” represent a value, amount, or characteristic close to the stated value, amount, or characteristic that still performs a desired function or achieves a desired result. For example, the terms “approximately,” “about,” “generally,” and “substantially” may refer to an amount that is within ±10% of, within ±5% of, within ±2% of, within ±1% of, or within ±0.1% of the stated amount. As another example, the terms “generally parallel” and “substantially parallel” refer to a value, amount, or characteristic that departs from exactly parallel by ±10 degrees, by ±5 degrees, by ±2 degrees, by ±1 degree, or by ±0.1 degree, and the terms “generally perpendicular” and “substantially perpendicular” refer to a value, amount, or characteristic that departs from exactly perpendicular by ±10 degrees, by ±5 degrees, by ±2 degrees, by ±1 degree, or by ±0.1 degree. The ranges disclosed herein also encompass any and all overlap, sub-ranges, and combinations thereof. Language such as “up to,” “at least,” “greater than,” less than,” “between,” and the like includes the number recited. As used herein, the meaning of “a,” “an,” and “said” includes plural reference unless the context clearly dictates otherwise. Also, as used in the description herein, the meaning of “in” includes “into” and “on,” unless the context clearly dictates otherwise.

While the structures and/or methods are discussed herein in terms of elements labeled by ordinal adjectives (e.g., first, second, etc.), the ordinal adjectives are used merely as labels to distinguish one element from another, and the ordinal adjectives are not used to denote an order of these elements or of their use.

Various configurations have been described above. It is to be appreciated that the implementations disclosed herein are not mutually exclusive and may be combined with one another in various arrangements. Although this invention has been described with reference to these specific configurations, the descriptions are intended to be illustrative of the invention and are not intended to be limiting. Various modifications and applications may occur to those skilled in the art without departing from the true spirit and scope of the invention. Thus, for example, in any method or process disclosed herein, the acts or operations making up the method/process may be performed in any suitable sequence and are not necessarily limited to any particular disclosed sequence. Features or elements from various implementations and examples discussed above may be combined with one another to produce alternative configurations compatible with implementations disclosed herein. In addition, although the disclosed methods and apparatuses have largely been described in the context of various devices, various implementations described herein can be incorporated in a variety of other suitable devices, methods, and contexts.

Various aspects and advantages of the implementations have been described where appropriate. It is to be understood that not necessarily all such aspects or advantages may be achieved in accordance with any particular implementation. Thus, for example, it should be recognized that the various implementations may be carried out in a manner that achieves or optimizes one advantage or group of advantages as taught herein without necessarily achieving other aspects or advantages as may be taught or suggested herein.

What is claimed is:

1. An apparatus comprising:
at least one x-ray source configured to generate x-rays;
at least one capillary x-ray focusing optic configured to receive and focus at least some of the generated x-rays into a focused x-ray beam; and
at least one x-ray optical component configured to receive the generated x-rays and/or the focused x-ray beam such that a focus size δ₁ of the focused x-ray beam is smaller than a focus size δ₀ of the focused x-ray beam without the at least one x-ray optical component.

2. The apparatus of claim 1, wherein the at least one x-ray source has a spot size less than 25 microns and the focus size δ₁ of the focused x-ray beam is less than 10 microns.

3. The apparatus of claim 1, wherein the at least one capillary x-ray focusing optic has a demagnification greater than 1 and a point spread function less than 10 microns and the focus size δ₁ of the focused x-ray beam is less than 10 microns.

4. The apparatus of claim 1, wherein the at least one x-ray source comprises a reflection-geometry x-ray source comprising at least one electron beam generator and at least one x-ray target configured to generate the x-rays in response to being irradiated by at least one electron beam from the at least one electron beam generator.

5. The apparatus of claim 1, wherein the at least one capillary x-ray focusing optic comprises a Wolter optic.

6. The apparatus of claim 1, wherein the at least one capillary x-ray focusing optic has a surface profile comprising at least one segment of a rotationally symmetric quadric surface.

7. The apparatus of claim 1, wherein the at least one x-ray optical component comprises a refractive corrector plate.

8. The apparatus of claim 1, wherein the at least one x-ray optical component comprises a mask configured to block x-rays from impinging predetermined regions of the at least one capillary x-ray focusing optic or to block x-rays reflecting from predetermined regions of the at least one capillary x-ray focusing optic.

9. An apparatus comprising:
at least one x-ray source configured to generate x-rays;
at least one capillary x-ray focusing optic configured to receive and focus at least some of the generated x-rays into a focused x-ray beam; and
at least one x-ray optical component configured to receive the generated x-rays and/or the focused x-ray beam such that a collective point spread function (PSF) of the at least one x-ray focusing optic and the at least one x-ray optical component is below 1 micron.

10. The apparatus of claim 9, wherein the collective PSF of the at least one x-ray focusing optic and the at least one x-ray optical component is below 0.5 micron.

11. The apparatus of claim 9, wherein a focus size of the focused x-ray beam is less than 10 microns.

12. The apparatus of claim 11, wherein the at least one x-ray source has a spot size less than 25 microns.

13. The apparatus of claim 9, wherein the at least one capillary x-ray focusing optic has a demagnification greater than 3.

14. The apparatus of claim 9, wherein the at least one capillary x-ray focusing optic has a PSF less than 3 microns.

15. The apparatus of claim 9, wherein the focused x-ray beam is configured to impinge a sample with a spot size greater than the collective PSF.

16. The apparatus of claim 9, wherein the at least one capillary x-ray focusing optic receives the generated x-rays from the at least one x-ray source and the at least one x-ray optical component receives the focused x-ray beam from the at least one capillary x-ray focusing optic.

17. The apparatus of claim 9, wherein the at least one x-ray optical component receives the generated x-rays from the at least one x-ray source and modifies a spatial distribution of the generated x-rays, and the at least one capillary x-ray focusing optic receives the generated x-rays from the at least one x-ray optical component.

18. The apparatus of claim 9, wherein the at least one x-ray optical component is configured to reduce a FWHM focus size P of the at least one capillary x-ray focusing optic.

19. The apparatus of claim 9, wherein the at least one x-ray optical component comprises at least one refractive three-dimensional optic.

20. The apparatus of claim 9, wherein the at least one x-ray optical component comprises at least one mask.
